(19) United States
(12) Patent Application Publication
(10) Pub. No.: US 2014/0146567 A1
(43) Pub. Date: May 29, 2014

(54) OPTICAL ELEMENT AND LED LIGHTING DEVICE HAVING SAME

(71) Applicant: HON HAI PRECISION INDUSTRY CO., LTD., New Taipei (TW)

(72) Inventor: PO-CHOU CHEN, New Taipei (TW)

(73) Assignee: HON HAI PRECISION INDUSTRY CO., LTD., New Taipei (TW)

(21) Appl. No.: 13/738,940

(22) Filed: Jan. 10, 2013

(30) Foreign Application Priority Data
Nov. 26, 2012 (TW) 101144205

(51) Int. Cl. F21V 13/02

(52) U.S. Cl. CPC F21V 13/02
USPC 362/609

(57) ABSTRACT

An optical element including a light guide plate and a cone-shaped reflector is provided. The light guide plate has a first surface, a second surface, a first side surface and a second side surface. The light guide plate defines a through hole in a middle portion thereof, which is surrounded by the second side surface. The cone-shaped reflector is received in the through hole of the light guide plate. The cone-shaped reflector includes an upper surface and a tapered lateral surface. The tapered lateral surface of the cone-shaped reflector is received in the through hole of the light guide plate. An LED lighting device having the optical element is also provided. Light generated by an LED is reflected by the tapered lateral surface of the cone-shaped reflector to enter the light guide via the second side surface.

### BACKGROUND

1. Technical Field

The disclosure generally relates to an optical element, and particularly relates to an optical element with uniform light distribution and a lighting device having the optical element, wherein the light device uses an LED (light emitting diode) as a light source.

2. Description of Related Art

In recent years, due to excellent light quality and high luminous efficiency, light emitting diodes (LEDs) have increasingly been used as substitutes for incandescent bulbs, compact fluorescent lamps and fluorescent tubes as light sources of illumination devices.

Generally, light intensity of a light emitting diode gradually decreases from a middle portion to lateral sides thereof. However, in many applications, people aim to obtain a light emitting diode with a uniform light distribution.

What is needed, therefore, is an optical element and an LED lighting device having the optical element to overcome the above described disadvantages.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an exploded, isometric view of an optical element in accordance with a first embodiment of the present disclosure.

FIG. 2 is a cross sectional view of the optical element in FIG. 1.

FIG. 3 is a cross sectional view of an LED lighting device having the optical element in FIG. 1.

FIG. 4 is a cross sectional view of an LED lighting device in accordance with a second embodiment of the present disclosure.

FIG. 5 is a cross sectional view of an LED lighting device in accordance with a third embodiment of the present disclosure.

### DETAILED DESCRIPTION

Embodiments of an optical element and an LED lighting device will now be described in detail below and with reference to the drawings.

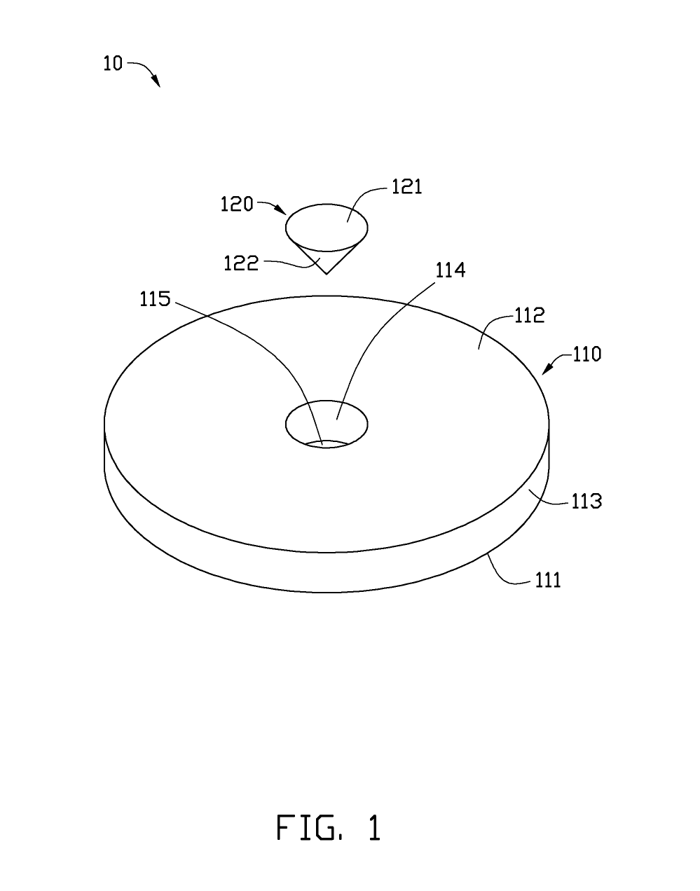

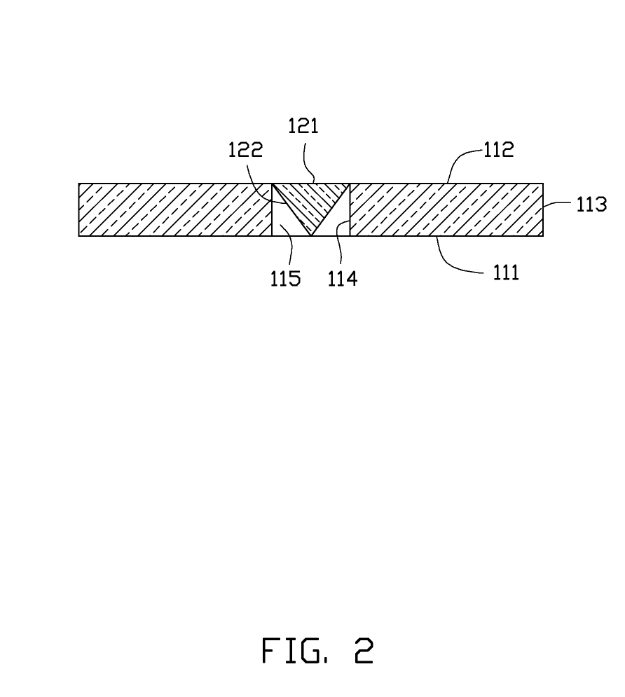

Referring to FIG. 1 and FIG. 2, an optical element 10 in accordance with a first embodiment is provided. The optical element 10 is made of a material selected from a group consisting of polycarbonate (PC), polymethyl methacrylate (PMMA) and glass. The optical element 10 includes a light guide plate 110 and a cone-shaped reflector 120.

The light guide plate 110 has a first surface 111, a second surface 112 parallel and opposite to the first surface 111, a first side surface 113 and a second side surface 114 connected between the first surface 111 and the second surface 112. In this embodiment, the first side surface 113 is formed at an external portion of the light guide plate 110, and the second side surface 114 is formed at an inner portion of the light guide plate 110. The light guide plate 110 defines a through hole 115 in a middle portion thereof and the through hole 115 is surrounded by the second side surface 114. In this embodiment, the through hole 115 has a round through hole. Alternatively, the through hole 115 can have other shape.

The cone-shaped reflector 120 is received in the through hole 115 of the light guide plate 110. The cone-shaped reflector 120 has an upper surface 121 which is flat and a lateral surface 122 which is tapered downwardly toward a bottom tip. In other words, the lateral surface 122 of the cone-shaped reflector 120 is inclined upwardly and outwardly from the bottom tip to the upper surface 121 of the cone-shaped reflector 120. The upper surface 121 of the cone-shaped reflector 120 is parallel to the first surface 111 and the second surface 112. The lateral surface 122 of the cone-shaped reflector 120 is received in the through hole 115 of the light guide plate 110. Preferably, the upper surface 121 of the cone-shaped reflector 120 which is round has a diameter the same as that of the through hole 115, whereby the upper surface 121 of the cone-shaped reflector 120 can be fittingly received in the through hole 115, with the upper surface 121 being coplanar with the second surface 112.

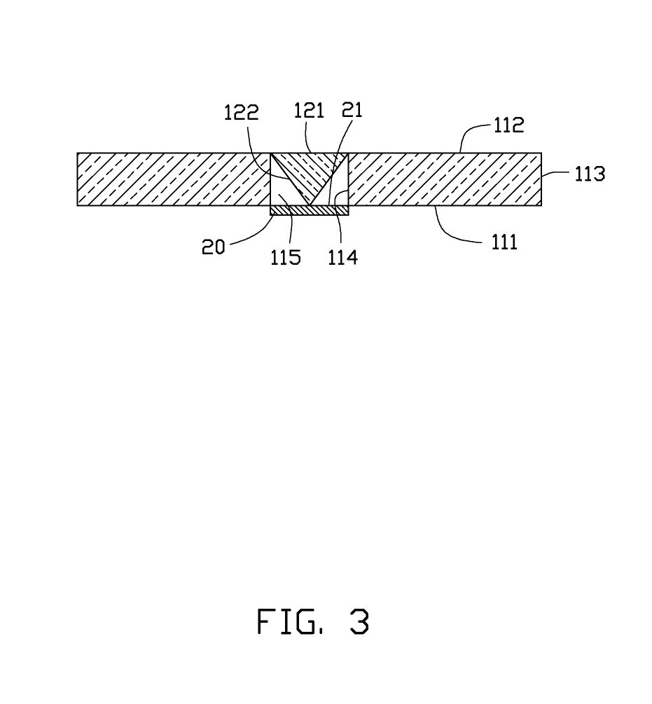

FIG. 3 shows an LED lighting device having the optical element 10. In addition to the optical element 10, the LED lighting device further includes a light source 20. The light source 20 is a light emitting diode. The light source 20 has a light emitting surface 21. The light emitting surface 21 of the light source 20 is received in the through hole 115 of the light guide plate 110 and faces the lateral surface 122 of the cone-shaped reflector 120. The light source 20 emits light from the light emitting surface 21. Light from the light emitting surface 21 is reflected by the lateral surface 122 of the cone-shaped reflector 120 to enter the light guide plate 110 from the second side surface 114. Then the light passes through the light guide plate 110 and emits into the surrounding environment via the second surface 112 and the first side surface 113 of the light guide plate 110.

In the optical element 10 and the LED lighting device described above, because the through hole 115 is formed in the middle portion of the light guide plate 110 and the cone-shaped reflector 120 is received in the through hole 115, when the light source 20 is received in the through hole 115, the light from the light source 20 will be reflected by the lateral surface 122 of the cone-shaped reflector 120 to enter the light guide plate 110 via the second side surface 114. That is, light in the middle portion of the light source 20 is dispersed by the cone-shaped reflector 120, thereby forming a uniform light distribution.

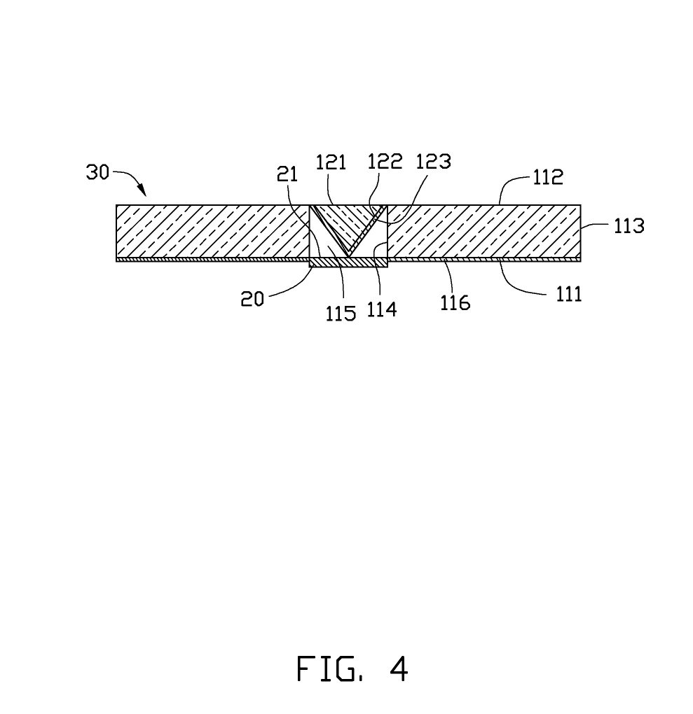

Referring to FIG. 4, an LED lighting device incorporating an optical element 30 in accordance with a second embodiment is provided. Compared with the optical element 10, the optical element 30 further includes a first reflective layer 116 formed on the first surface 111 of the light guide plate 110. When the optical element 30 replaces the optical element 10 in the LED lighting device, the first reflective layer 116 can reflect the light from the second side surface 114 of the light guide plate 110 toward the first surface 11 to make the light be totally directed out of the light guide plate 110 from the second surface 112 and the first side surface 113, without from the first surface 111 which can cause a light loss. Preferably, the lateral surface 122 of the cone-shaped reflector 120 can be coated with a second reflective layer 123. The second reflective layer 123 can reflect light from the light source 20 to make the light be totally directed into the light guide plate 110 through the second side surface 114 of the light guide plate 110.

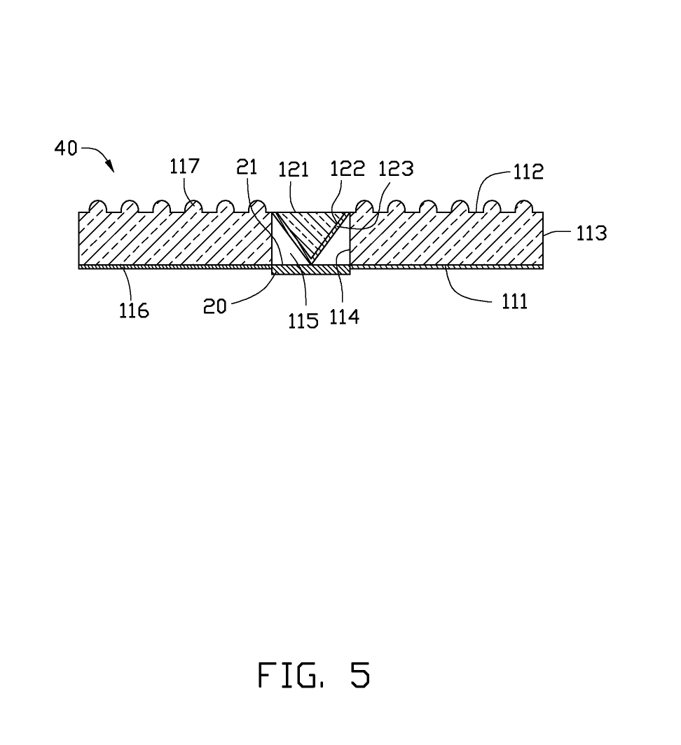

Referring to FIG. 5, an LED lighting device incorporating an optical element 40 in accordance with a third embodiment is provided. Compared with the optical element 30, the optical element 40 further includes a plurality of protrusions 117 formed at the second surface 112 of the light guide plate 110. When the optical element 40 replaces the optical element 30 in the LED lighting device, the protrusions 117 can scatter light which radiates out of the light guide plate 110 from the second surface 112, thereby obtaining a uniform light distribution.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An optical element, comprising:
a light guide plate comprising a first surface, a second surface opposite and parallel to the first surface, a first side surface and a second side surface connected between the first surface and the second surface, the light guide plate defining a through hole in a middle portion thereof, the through hole being surrounded by the second side surface; and
a cone-shaped reflector received in the through hole of the light guide plate, the cone-shaped reflector comprising an upper flat surface and a tapered lateral surface, the tapered lateral surface of the cone-shaped reflector being received in the through hole of the light guide plate and configured for reflecting light from a light source into the light guide plate via the second side surface.

2. The optical element of claim 1, wherein the light guide plate further comprises a plurality of protrusions formed on the second surface of the light guide plate, the upper flat surface of the cone-shaped reflector being located adjacent to the second surface of the light guide plate.

3. The optical element of claim 1, wherein a first reflective layer is formed on the first surface of the light guide plate.

4. The optical element of claim 3, wherein a second reflective layer is formed on the tapered lateral surface of the cone-shaped reflector.

5. The optical element of claim 1, wherein the through hole is a round through hole.

6. The optical element of claim 5, wherein the upper flat surface of the cone-shaped reflector is round, the upper flat surface of the cone-shaped reflector being flush with the second surface of the light guide plate.

7. The optical element of claim 1, wherein the optical element is made of a material selected from a group consisting of polycarbonate, polymethyl methacrylate and glass.

8. An LED (light emitting diode) lighting device, comprising:
an optical element comprising a light guide plate and a cone-shaped reflector, the light guide plate having a first surface, a second surface opposite and parallel to the first surface, a first side surface and a second side surface connected between the first surface and the second surface, the light guide plate defining a through hole in a middle portion thereof, the through hole being surrounded by the second side surface, the cone-shaped reflector being received in the through hole of the light guide plate, the cone-shaped reflector comprising an upper surface and a tapered lateral surface tapered downward toward the first surface of the light guide plate, the upper surface of the cone-shaped reflector being parallel to the first surface and the second surface, the lateral surface of the cone-shaped reflector being received in the through hole of the light guide plate; and
a light source which is an LED having a light emitting surface, the light emitting surface of the light source being received in the through hole of the light guide plate and facing the lateral surface of the cone-shaped reflector, light from the light emitting surface of the light source being reflected by the lateral surface of the cone-shaped reflector to enter the light guide plate through the second side surface of the light guide plate.

9. The LED lighting device of claim 8, wherein the light guide plate further comprises a plurality of protrusions formed on the second surface of the light guide plate.

10. The LED lighting device of claim 8, wherein a first reflective layer is formed on the first surface of the light guide plate.

11. The LED lighting device of claim 10, wherein a second reflective layer is formed on the lateral surface of the cone-shaped reflector.

12. The LED lighting device of claim 8, wherein the through hole has is a round through hole.

13. The LED lighting device of claim 12, wherein the upper surface of the cone-shaped reflector is round and has a diameter the same as that of the through hole, the upper surface being fittingly received in the through hole and coplanar with the second surface of the light guide plate

14. The LED lighting device of claim 8, wherein the optical element is made of a material selected from a group consisting of polycarbonate, polymethyl methacrylate and glass.
